(19) United States
(12) Patent Application Publication
(10) Pub. No.: US 2026/0250800 A1
(43) Pub. Date: Aug. 27, 2026

(54) HIGH-PRESSURE REACTOR

(71) Applicants: PT ESG NEW ENERGY MATERIAL, Jakarta Selatan, Dki Jakarta (ID); PT QMB NEW ENERGY MATERIALS, Jakarta Selatan, Dki Jakarta (ID); GEM CO., LTD., SHENZHEN, GUANGDONG (CN); PT GEM INDONESIA NEW ENERGY MATERIALS, Jakarta Selatan, Dki Jakarta (ID)

(72) Inventors: SATRYO SOEMANTRI BRODJONEGORO, JAKARTA SELATAN, DKI JAKARTA (ID); KAIHUA XU, SHENZHEN, GUANGDONG (CN); YI WANG, JAKARTA SELATAN, DKI JAKARTA (ID); EVAN WAHWAHYU KRISTIYANTO, JAKARTA SELATAN, DKI JAKARTA (ID); AAD ALIEF RASYRASYIDI BAKING, JAKARTA SELATAN, DKI JAKARTA (ID); TEGAR MUKTI AJI, JAKARTA SELATAN, DKI JAKARTA (ID); RIZKY WANALDI, JAKARTA SELATAN, DKI JAKARTA (ID); ANDI SYAPUTRA HASIBUAN, JAKARTA SELATAN, DKI JAKARTA (ID); ARNALDO MARULITUA SINAGA, JAKARTA SELATAN, DKI JAKARTA (ID)

(21) Appl. No.: 18/870,453

(22) PCT Filed: Jun. 29, 2023
(86) PCT No.: PCT/CN2023/103767

§ 371 Date: Nov. 29, 2024

(51) Int. Cl. C22B 3/02; C22B 3/00; C22B 3/08

(52) U.S. Cl. CPC C22B 3/02; C22B 3/08; C22B 23/043

(57) ABSTRACT

Disclosed is a high-pressure reactor comprising a reactor with one end as a feed inlet and the other end as a discharge outlet. Inside the reactor, a plurality of partition plates are arranged along the material flow direction, dividing the interior cavity of the reactor into multiple compartments; on the compartment for feeding material, an ore pulp inlet, a steam inlet, and an acid inlet are sequentially arranged circumferentially along the stirring direction with the mixing device in the compartment as the axis. In this disclosure, after the ore pulp enters the reactor vessel, under the stirring action of the mixing device, the ore pulp first comes into contact with steam to continue heating up, and then it contacts the acid to react with it. The reaction with the acid is exothermic, and the heat generated by the reaction is utilized to heat the newly incoming ore pulp.

### FIELD OF THE DISCLOSURE

The disclosure relates to the technical field of reactor, in particular to a high-pressure reactor.

### BACKGROUND

With the vigorous development of China's new-energy vehicle industry and the gradual depletion of high-quality nickel and cobalt mine resources in the country, the demand for Ni, Co, and Mn metals in ternary materials for new energy sources is rising steadily. As a result, the exploitation of laterite nickel ore, which has large reserves but low nickel grades, has gradually become a hot spot in the industry. The hydrometallurgical route involving sulfuric acid leaching under high-temperature and high-pressure conditions is currently one of the mainstream smelting processes for laterite nickel ore.

Reactor is a primary equipment for sulfuric acid leaching under high-temperature and high-pressure condition. For instance, a Chinese patent with application number CN201721318428.6 discloses a pressurized continuous hydrometallurgical reactor, which comprises: a horizontal reactor equipped with a feed pipe on one side and a discharge pipe on the other side, with more than one compartment inside the horizontal reactor. Inside the horizontal reactor, there are stirring devices, temperature control devices, heating devices, cooling devices, and pressure control devices, all controlled according to conventional methods.

Regarding the aforementioned existing technology, within horizontal high-pressure reactors, mixing of mineral slurry, steam, and acid is typically carried out using stirring devices. However, with traditional stirring structures, some materials with higher specific gravity tend to settle at the bottom, resulting in uneven distribution of materials in the vertical direction. Additionally, steam needs to be introduced to heat the newly injected mineral slurry to the required reaction temperature before a reaction can occur. The long heating time required for the mineral slurry, combined with the low degree of material mixing uniformity due to the uneven vertical distribution, leads to inefficient reaction processes. To date, no effective solutions have been proposed to address the issues associated with these related technologies.

### SUMMARY

The purpose of this disclosure is to provide a high-pressure reactor to solve the technical problems of long heating time for the slurry in the reaction and low material mixing uniformity in the existing technology.

In order to solve the above technical problems, this disclosure provides a high-pressure reactor, comprising:
a reactor, which is provided with a feed inlet at one end and a discharge outlet at the other end, the feed inlet is used for injecting slurry, steam, and acid, while the discharge outlet is used for discharging; inside the reactor, several partition plates are arranged sequentially along the direction of material flow; these partition plates divide the interior cavity of the reactor into multiple compartments; each compartment is equipped with a mixing device; the upper parts of any two adjacent compartments are connected;
a feed inlet, which comprises an ore pulp inlet, a steam inlet, and an acid inlet that are sequentially arranged circumferentially along the direction of stirring rotation with the mixing device as an axis; and,
a mixing device, which comprises a driving component, a propeller stirring paddle, and a disc disperser stirring paddle; the driving component is used to drive the rotation of the propeller stirring paddle and the disc disperser stirring paddle; the disc disperser stirring paddle is located above the propeller stirring paddle; the propeller stirring paddle is used to disturb and mix the materials and promote their upward movement; the disc disperser stirring paddle is used to tangentially disperse the upward-moving materials.

Furthermore, the ore pulp inlet comprises a first ore pulp port located near the acid inlet and a second ore pulp port located near the steam inlet.

Furthermore, a turbulence plate is installed within the compartment to disturb the flow trajectory of the internal fluid.

Furthermore, the turbulence plate is distributed on the inner walls surrounding the compartment.

Furthermore, a plurality of round holes are unevenly distributed on the turbulence plate, these round holes allow the slurry to accelerate through.

Furthermore, the bottom of the partition plate is provided with bottom holes for the slurry to pass through.

Furthermore, the upper heights of several partition plates decrease sequentially along the direction of material flow, causing the liquid levels of several compartments decrease sequentially along the direction of material flow.

Furthermore, a wear-resistant plate is installed on the inner bottom wall of the reactor.

Furthermore, the wear-resistant plate is made of titanium alloy.

Furthermore, the disc disperser stirring paddle is positioned below the liquid level of the compartment, while the propeller stirring paddle is located at the lower part of the compartment.

Furthermore, the driving component comprises a drive motor and a rotating shaft; the rotating shaft is connected to the output shaft of the drive motor, and both the propeller stirring paddle and the disc disperser stirring paddle are installed on the rotating shaft.

Furthermore, the reactor vessel of the reactor is divided into three layers from the inside out: a titanium alloy layer, an iron casting layer, and an insulating layer.

Furthermore, the thickness of the iron casting layer ranges from 30.5 to 95 mm.

Furthermore, the thickness of the titanium alloy layer is between 4 and 30 mm.

Furthermore, the thickness of the insulating layer is between 60 and 140 mm.

Furthermore, the impeller of the propeller stirring paddle has either three or four blades, and the angle of the blades is between 12 and 42 degrees.

Furthermore, the length of the blades is between 400 and 1500 mm.

Furthermore, the rotational speed of the propeller stirring paddle is between 0 and 960 rpm.

Furthermore, the thickness of the wear-resistant plate is between 4 and 30 mm.

Compared with existing technologies, the beneficial effects of this disclosure are:
(1) the first ore pulp port, second ore pulp port, steam inlet, and acid inlet are sequentially arranged around the mixing device according to the stirring direction of the mixing device; with this arrangement, after entering the reactor vessel, the ore pulp first comes into contact with steam under the stirring action of the mixing device and continues to heat up, then it encounters the acid and reacts with it; the reaction with the acid is exothermic, and the heat generated by the reaction is utilized to heat the newly incoming ore pulp;
(2) utilizing a dual-layer stirring paddle configuration, with a propeller stirring paddle positioned below and a disc disperser stirring paddle above, this setup lifts materials from the bottom and then disperses them, enhancing mixing efficiency and accelerating the reaction process;
(3) the turbulence plate disturbs the internal fluid and features round holes that allow a small portion of the slurry to pass through, accelerating the dispersion of materials behind the turbulence plate and preventing the formation of a wake zone;
(4) the compartment with a stepped liquid level, combined with bottom holes on the partition plate, promotes a faster flow velocity of the slurry;
(5) the thickness of the bottom of the reactor vessel is increased with titanium alloy plates to extend the time before the bottom is worn through.

### BRIEF DESCRIPTION OF THE DRAWINGS

FIG. 1 is a schematic diagram showing the overall structure of a high-pressure reactor according to an embodiment of this disclosure;

FIG. 2 is a front view of the high-pressure reactor according to an embodiment of this disclosure;

FIG. 3 is a top view of the high-pressure reactor according to an embodiment of this disclosure;

FIG. 4 is a left-side view of the high-pressure reactor according to an embodiment of this disclosure.

### DETAILED DESCRIPTION OF PREFERRED EMBODIMENTS

The preferred embodiments of this disclosure will be described in detail with reference to the accompanying drawings, which constitute a part of this disclosure and are used together with the embodiments to illustrate the principles of this disclosure, and are not intended to limit the scope of this disclosure.

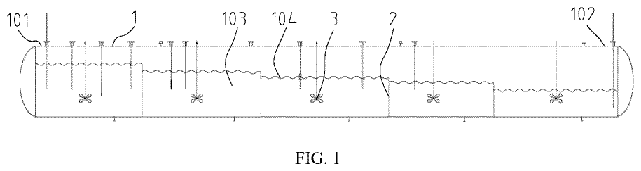

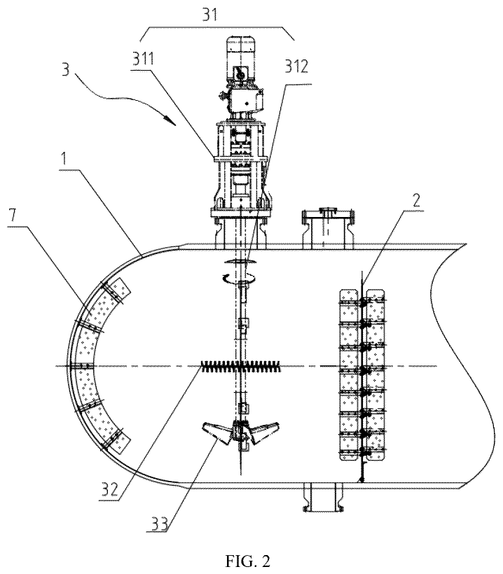

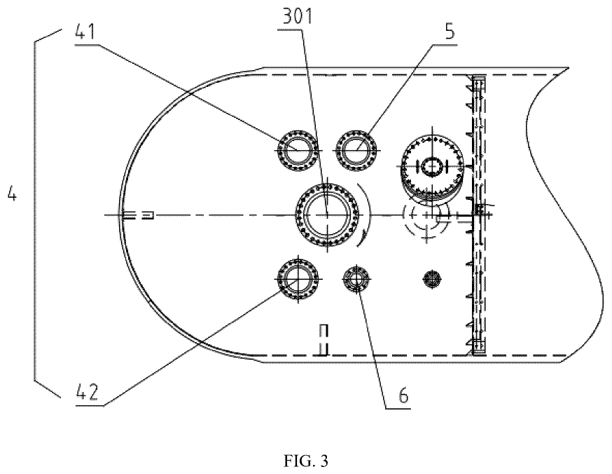

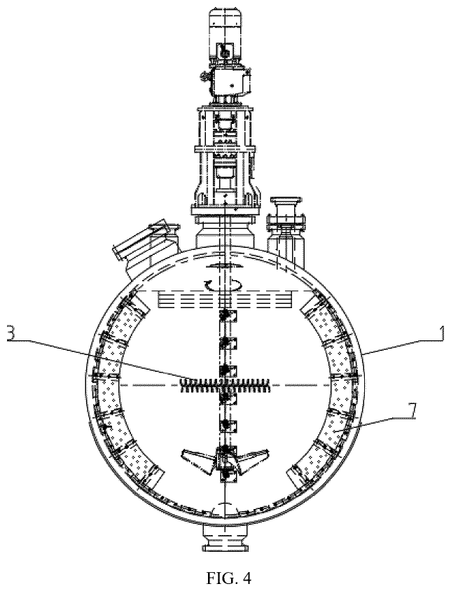

As shown in FIG. 1-FIG. 4, this disclosure provides a high-pressure reactor, comprising a reactor 1 with a feed inlet 101 at one end and a discharge outlet 102 at the other end. The feed inlet 101 is used for injecting slurry, steam, and acid, while the discharge outlet 102 is used for discharging. Inside the reactor 1, several partition plates 2 are arranged sequentially along the direction of material flow. These partition plates 2 divide the interior cavity of the reactor 1 into multiple compartments 103. Each compartment 103 is equipped with a mixing device 3. Additionally, the upper parts of any two adjacent compartments 103 are connected, and a rat-hole design is adopted at the bottom to allow materials to enter from the feed inlet 101, flow through each compartment 103 in sequence, and finally be discharged through the discharge outlet 102. Furthermore, within each compartment, the materials are mixed and stirred by the mixing device 3.

To achieve the effect of reducing the time required for slurry heating upon feeding at the feed inlet 101, the feed inlet 101 is located on the compartment 103 closest to feeding end. The feed inlet 101 comprises an ore pulp inlet 4, a steam inlet 5, and an acid inlet 6, which are sequentially arranged circumferentially along the direction of stirring rotation with the mixing device 3 as an axis. The ore pulp inlet 4 is used to inject slurry, the steam inlet 5 is used to inject high-temperature steam, and the acid inlet 6 is used to inject acid. Due to the circumferential arrangement of the ore pulp inlet 4, steam inlet 5, and acid inlet 6 along the stirring direction, under the stirring action of the mixing device 3, the slurry first contacts the steam and is heated to the reaction temperature before coming into contact with the acid to react with it. The reaction with acid is exothermic, and the heat generated by the reaction is utilized to preheat the subsequent slurry entering from the ore pulp inlet 4, thereby making use of the heat released by the reaction and reducing the time required for the slurry to be heated to the reaction temperature by steam.

Furthermore, to enhance the efficiency of mixing various materials and reduce material settlement, the mixing device 3 comprises a driving component 31, a propeller stirring paddle 32, and a disc disperser stirring paddle 33. The driving component 31 is used to drive the rotation of the propeller stirring paddle 32 and the disc disperser stirring paddle 33. The disc disperser stirring paddle 33 is located above the propeller stirring paddle 32. The propeller stirring paddle 32 is used to disturb and mix the materials and promote their upward movement. The disc disperser stirring paddle 33 is used to tangentially disperse the upward-moving materials to achieve further mixing. By using the propeller stirring paddle 32 to disturb and lift materials with a higher specific gravity from the bottom, the disc disperser stirring paddle 33 can perform high-speed tangential dispersion on the lifted materials. The coordinated action of the dual stirring paddles enhances mixing efficiency, thereby accelerating the reaction process.

During operation, the mixing device 3, in coordination with the circumferentially distributed ore pulp inlet 4, steam inlet 5, and acid inlet 6, stirs and produces a superimposed slurry heating effect, which shortens the time required for the slurry to reach the reaction temperature. Additionally, through the coordinated action of dual stirring, the mixing device 3 disrupts and brings larger particles from the bottom to the surface, while simultaneously dispersing these ascending particles at high speeds in a tangential direction. This efficient mixing of materials facilitates a rapid progression of the reaction.

The reactor vessel of the reactor 1 is divided into three layers from the inside out: a titanium alloy layer, an iron casting layer, and an insulating layer. The thickness of the iron casting layer ranges from 30.5 to 95 mm. The thickness of the titanium alloy layer is between 4 and 30 mm, and the thickness of the insulating layer is between 60 and 140 mm.

Additionally, the impeller of the propeller stirring paddle 32 has either three or four blades, and the angle of the blades is between 12 and 42 degrees. The length of the blades is between 400 and 1500 mm. The rotational speed of the propeller stirring paddle 32 is between 0 and 960 rpm.

It should be clarified that, depending on the capacity of the reactor vessel, each compartment 103 can be equipped with additional steam inlet 5, acid inlet 6, and vent port, as well as auxiliary tools such as thermometer and liquid level indicator, as appropriate.

In an embodiment, to enhance the slurry preheating effect, the ore pulp inlet 4 comprises a first ore pulp port 41 located near the acid inlet 6 and a second ore pulp port 42 located near the steam inlet 5. The slurry is divided into two streams and injected into the first ore pulp port 41 and the second ore pulp port 42, respectively. The slurry from the second ore pulp port 42 first contacts the steam, heated to the reaction temperature, and then comes into contact with the acid injected from the acid inlet 6, resulting in an exothermic reaction. This slurry then comes into contact with the slurry injected from the first ore pulp port 41. Since the first ore pulp port 41 is closer to the acid inlet 6, it can more quickly come into contact with the heat generated by the reaction and has a longer duration of contact with the steam injected from the steam inlet 5, thereby extending its preheating time. By injecting the slurry in a divided flow and connecting it in a circulatory manner, the exothermic reaction between the slurry and acid is fully utilized to achieve better heating efficiency.

It is understandable that by dividing the slurry into two streams, the slurry from the second ore pulp port 42 can more fully undergo heat exchange with the steam, while the slurry from the first ore pulp port 41 undergoes preheating under the exothermic reaction. This reduces the amount of heat that needs to be exchanged with steam subsequently, thereby achieving the effect of fully utilizing the exothermic reaction between the slurry and acid.

In an embodiment, in order to achieve a more uniform mixing of various materials, a turbulence plate 7 is installed within the compartment 103 to disturb the flow trajectory of the internal fluid. Under the action of the turbulence plate 7, the flow path of the materials is disrupted, achieving the effect of turbulent mixing.

Furthermore, to achieve a more thorough disturbance effect, the turbulence plate 7 is distributed on the inner walls surrounding the compartment 103.

Furthermore, to reduce the deposition and scaling of materials caused by the turbulence plate 7, a plurality of round holes 701 are unevenly distributed on the turbulence plate 7. These round holes 701 allow the slurry to accelerate through, helping to mitigate deposition and scaling.

It is understandable that when the turbulence plate 7 reaches a certain size, a large wake zone will form on the backside of the turbulence plate 7. Within the wake zone, the flow velocity is very low, which can lead to issues with material deposition and scaling. If the turbulence plate 7 is too small, the turbulence effect will not be significant. The round holes 701 allow the slurry to accelerate and penetrate through the turbulence plate 7. This creates an impact on the slurry after disturbance, accelerating the dispersion of materials behind the turbulence plate and preventing the formation of the wake zone.

In an embodiment, to achieve a faster flow velocity of the slurry between the compartments 103, the bottom of the partition plate 2 is provided with bottom holes for the slurry to pass through. These bottom holes form interconnected channels at the lower part of the compartments 103, allowing the slurry to flow through.

Furthermore, the upper heights of several partition plates 2 decrease sequentially along the direction of material flow, causing the liquid levels 104 of several compartments 103 decrease sequentially along the direction of material flow. This results in a pressure difference at the bottoms of the compartments 103, driving the slurry at the bottoms of the compartments 103 to flow through the bottom holes. This, in turn, generates a faster flow velocity for the slurry.

It is understandable that with increased slurry flow velocity and a fixed reaction time, the reactor vessel can be made larger, resulting in greater processing capacity.

It should be noted that the reaction between the slurry and acid continues from the moment the slurry enters the reactor 1 until it leaves the reactor 1. The high-pressure reactor 1 is designed in size to ensure that the time it takes for the slurry to flow through the reactor 1 is equal to or slightly greater than the time required for the slurry to fully react.

In an embodiment, to prolong the time before the bottom of the reactor 1 is worn through, a wear-resistant plate is installed on the inner bottom wall of the reactor 1.

Furthermore, the wear-resistant plate is made of titanium alloy, which has properties of acid corrosion resistance and wear resistance. Essentially, installing the wear-resistant plate is equivalent to increasing the thickness of the easily worn bottom of the reactor, thereby prolonging the time before it is worn through. The thickness of the wear-resistant plate is between 4 and 30 mm.

It should be noted that the titanium alloy plate is made of TA10 titanium alloy, and the wear-resistant plate is installed in specific areas at the bottom of the reactor 1.

In an embodiment, to ensure effective stirring in each compartment, the disc disperser stirring paddle 33 is positioned below the liquid level 104 of the compartment 103, while the propeller stirring paddle 32 is located at the lower part of the compartment 103. This arrangement allows stirring within the range of the liquid level 104, ensuring effective mixing in each compartment 103.

Furthermore, to achieve coaxial rotation, the driving component 31 comprises a drive motor 311 and a rotating shaft 312. The rotating shaft 312 is connected to the output shaft of the drive motor 311, and both the propeller stirring paddle 32 and the disc disperser stirring paddle 33 are installed on the rotating shaft. The rotating shaft 312 vertically extends downward from the top of the reactor 1, with the disc disperser stirring paddle 33 and the propeller stirring paddle 32 distributed on the rotating shaft 312 from top to bottom.

The workflow of this disclosure is as follows: The feed inlet 101 comprises an ore pulp inlet 4, a steam inlet 5, and an acid inlet 6, which are sequentially arranged circumferentially along the direction of stirring rotation with the mixing device 3 as an axis. the ore pulp inlet 4 comprises a first ore pulp port 41 located near the acid inlet 6 and a second ore pulp port 42 located near the steam inlet 5. The slurry is divided into two streams and injected into the first ore pulp port 41 and the second ore pulp port 42, respectively. With stirring, the ore pulp in the second ore pulp port 42 comes into contact with steam, rises in temperature to the reaction temperature, and reacts with acid. Due to the exothermic reaction, the ore pulp injected through the first ore pulp port 41 is preheated. During stirring, the propeller stirring paddle 32 lifts the material near the bottom of the compartment 103, and the disc disperser stirring paddle 33 tangentially distributes the lifted material at high speed for mixing. During the stirring and mixing process, the turbulence plate 7 creates turbulence in the material, and some of the slurry accelerates through the round holes 701, creating an impact on the turbulated slurry. This not only reduces material deposition and scaling but also enhances the turbulence effect.

The entire workflow has ended, and any content not described in detail in this disclosure belongs to the existing technology known to professionals in this field.

The above is only a preferred specific embodiment of this disclosure, but the scope of protection of this disclosure is not limited to this. Any changes or substitutions that can be easily conceived by those skilled in the art within the scope of the disclosed technology should be included in the scope of protection of this disclosure.

What is claimed is:

1. A high-pressure reactor, comprising:
a reactor, which is provided with a feed inlet at one end and a discharge outlet at the other end, the feed inlet is used for injecting slurry, steam, and acid, while the discharge outlet is used for discharging; inside the reactor, several partition plates are arranged sequentially along the direction of material flow; these partition plates divide the interior cavity of the reactor into multiple compartments; each compartment is equipped with a mixing device; the upper parts of any two adjacent compartments are connected;
a feed inlet, which comprises an ore pulp inlet, a steam inlet, and an acid inlet that are sequentially arranged circumferentially along the direction of stirring rotation with the mixing device as an axis; and,
a mixing device, which comprises a driving component, a propeller stirring paddle, and a disc disperser stirring paddle; the driving component is used to drive the rotation of the propeller stirring paddle and the disc disperser stirring paddle; the disc disperser stirring paddle is located above the propeller stirring paddle; the propeller stirring paddle is used to disturb and mix the materials and promote their upward movement; the disc disperser stirring paddle is used to tangentially disperse the upward-moving materials.

2. The high-pressure reactor according to claim 1, wherein the ore pulp inlet comprises a first ore pulp port located near the acid inlet and a second ore pulp port located near the steam inlet.

3. The high-pressure reactor according to claim 1, wherein a turbulence plate is installed within the compartment to disturb the flow trajectory of the internal fluid.

4. The high-pressure reactor according to claim 3, wherein the turbulence plate is distributed on the inner walls surrounding the compartment.

5. The high-pressure reactor according to claim 4, wherein a plurality of round holes are unevenly distributed on the turbulence plate, these round holes allow the slurry to accelerate through.

6. The high-pressure reactor according to claim 1, wherein the bottom of the partition plate is provided with bottom holes for the slurry to pass through.

7. The high-pressure reactor according to claim 6, wherein the upper heights of several partition plates decrease sequentially along the direction of material flow, causing the liquid levels of several compartments decrease sequentially along the direction of material flow.

8. The high-pressure reactor according to claim 1, wherein a wear-resistant plate is installed on the inner bottom wall of the reactor.

9. The high-pressure reactor according to claim 8, wherein the wear-resistant plate is made of titanium alloy.

10. The high-pressure reactor according to claim 1, wherein the disc disperser stirring paddle is positioned below the liquid level of the compartment, while the propeller stirring paddle is located at the lower part of the compartment.

11. The high-pressure reactor according to claim 10, wherein the driving component comprises a drive motor and a rotating shaft; the rotating shaft is connected to the output shaft of the drive motor, and both the propeller stirring paddle and the disc disperser stirring paddle are installed on the rotating shaft.

12. The high-pressure reactor according to claim 1, wherein the reactor vessel of the reactor is divided into three layers from the inside out: a titanium alloy layer, an iron casting layer, and an insulating layer.

13. The high-pressure reactor according to claim 12, wherein the thickness of the iron casting layer ranges from 30.5 to 95 mm.

14. The high-pressure reactor according to claim 13, wherein the thickness of the titanium alloy layer is between 4 and 30 mm.

15. The high-pressure reactor according to claim 14, wherein the thickness of the insulating layer is between 60 and 140 mm.

16. The high-pressure reactor according to claim 1, wherein the impeller of the propeller stirring paddle has either three or four blades, and the angle of the blades is between 12 and 42 degrees.

17. The high-pressure reactor according to claim 16, wherein the length of the blades is between 400 and 1500 mm.

18. The high-pressure reactor according to claim 17, wherein the rotational speed of the propeller stirring paddle 32 is between 0 and 960 rpm.

19. The high-pressure reactor according to claim 9, wherein the thickness of the wear-resistant plate is between 4 and 30 mm.
